(19) United States
(12) Patent Application Publication
(10) Pub. No.: US 2009/0301519 A1
(43) Pub. Date: Dec. 10, 2009

(54) Removal of dirt/make-up form unclean surfaces

(75) Inventor: Eric Aubay, Asnieres-Sur-Seine (FR)

Correspondence Address: BUCHANAN, INGERSOLL & ROONEY PC, POST OFFICE BOX 1404, ALEXANDRIA, VA, 22313-1404, US

(73) Assignee: Rhodia Chimie, Aubervilliers (FR)

(21) Appl. No.: 11/989,474

(22) PCT Filed: Jul. 25, 2006
(86) PCT No.: PCT/EP2006/007324

§ 371 Date: Aug. 26, 2009

Related U.S. Application Data
(60) Provisional application No. 60/701,975, filed on Jul. 25, 2005.

(51) Int. Cl. B08B 7/00

(52) U.S. Cl. 134/6

(57) ABSTRACT

Dirt or make-up is removed from a variety of unclean surfaces, such as domestic, institutional or body surfaces, by applying an ampholytic or zwitterionic polymer composition thereon, spreading and/or wiping such composition thereover, whereby dirt or make-up is or has been transferred into such composition, and then removing such composition therefrom, for example by means of a wipe, cloth, pad, sponge, mop, and the like.

### BACKGROUND OF THE INVENTION

The invention concerns a process for removing dirt or make-up from surfaces, such as domestic, institutional or body surfaces (keratinous surfaces such as skin or hair, or teeth surfaces) typically carried out when performing cleaning.

Cleaning of surfaces, for example hard surfaces or body surfaces, is an operation that is performed on a regular on non regular basis, for the sake of hygiene and/or comfort, and/or perception of hygiene or comfort. In cleaning, removing dirt from surfaces is one embodiment. Presence of dirt is easily perceived by people, who can feel a need for having it removed. Removal of dirt can be easily perceived by the person performing the cleaning.

The industry provides all sorts of means and compositions for performing cleaning and removal of dirt. The means and compositions are used by consumers in private places, when performing private house-hold, or by people performing institutional house-hold operations in public places, such as janitors and maids.

There is a need for improving dirt removal or perception of dirt removal, and/or for improving hygiene, comfort, and/or perception thereof. There is also a need for improving the efficiency of dirt removal (more dirt removed and/or same amount but quicker or with less efforts) or the perception thereof.

There is also a need for removing dirt or cosmetics such as make-up from body surfaces (keratinous surfaces such as skin or hair, or teeth surfaces). In polluted areas, particles deposit onto the hair and/or skin. They are to be removed or cleaned. Make-up can also be considered as dirt when it is to be removed. Also there is a need for removing sebum secretions or greasy substances from hair and/or skin.

There is also a need for removing dirt from plants.

### BRIEF SUMMARY OF THE INVENTION

The invention provides a process that addresses at least some of the needs mentioned above.

Thus the invention concerns a process for removing dirt or make-up form surfaces, comprising the steps of

a) Applying a fluid composition comprising an ampholytic or zwitterionic polymer onto the surface having dirt or make-up, by pouring or spraying the composition onto the surface or by using an application mean,
b) simultaneously or subsequently spreading and/or wiping the composition onto the surface, with a wiping or spreading fibrous or porous mean, and then,
c) optionally removing the liquid, or a part thereof, from the surface with a drying fibrous or porous mean,
some dirt or make-up being transferred from the surface to the application mean and/or the wiping mean and/or the spreading mean, and/or the drying mean.

The invention also concerns the use of the ampholytic or zwitterionic polymer for removing dirt or make-up, or improving dirt or make-up removal. In a particular embodiment it concerns the use of an ampholytic or zwitterionic polymer in a liquid composition for removing dirt from a domestic or institutional surface, for improving dirt removal. It also concerns the use of the liquid composition comprising the polymer in the process for removing dirt or make-up form surfaces.

The treated surface can be for example:

a domestic or institutional hard surface,

a tooth,

a keratinous surface such as skin or hair, or

a plant.

Without intending to be bound to any theory, it is believed that the ampholytic or zwitterionic polymer provides some interaction between the dirt and the application mean and/or the wiping mean and/or the spreading mean, and/or the drying mean, especially when theses means comprise a cellulosic material, said interaction helping in transferring the dirt from the surface to these means.

### DETAILED DESCRIPTION OF THE INVENTION

### Definitions

In the present specification “composition comprising a polymer” refers to a composition that can be used as such, or to a composition that is to be diluted before or during use (it can be referred to a “concentrate composition”) or to a composition in a diluted form (it can be referred to a “diluted composition”).

In the present specification “hard surface” refers to any surface found in homes or institutional buildings, or in industrial buildings, or in furniture, provided that the surface is not a fabric such as clothes, furniture fabrics, curtains, sheets.

The dirt or make-up transfer index is DeltaE=\sqrt{DL²+Da²+Db²} wherein:

DL=L before the process−L after the process
Da=a before the process−a after the process
Db=b before the process−b after the process L
a, and b are calorimetric CIE L*a*b* coordinates for example measure with a LU600 version 010892 type apparatus, of the surface before and after removal of dirt or make-up, or of the application mean and/or the wiping mean and/or the spreading mean, and/or the drying mean, before and after removal of dirt or make-up.

Domestic surfaces are understood as surfaces found in private buildings or parts of buildings such as houses and apartments, that are to be cleaned on a regular or not basis.

Institutional surfaces are understood as surfaces found in public buildings, such as work places, hotels, schools, administrations, entertainment facilities, that are to be cleaned on a regular or not basis.

In the present application, the expression “unit derived from a monomer” denotes a unit that can be obtained directly from said monomer by polymerization. Thus, for example, a unit derived from an acrylic or methacrylic acid ester does not cover a unit of formula —CH₂—CH(COOH)—, —CH₂—C(CH₃)(COOH)—, —CH₂—CH(OH)—, respectively, obtained for example by polymerizing an acrylic or methacrylic acid ester, or vinyl acetate, respectively, and then hydrolyzing. A unit derived from acrylic or methacrylic acid covers, for example, a unit obtained by polymerizing a monomer (for example an acrylic or methacrylic acid ester), and then reacting (for example by hydrolysis) the polymer obtained so as to obtain units of formula —CH₂—CH(COOH)—, or —CH₂—C(CH₃)(COOH)—. A unit derived from a vinyl alcohol covers, for example, a unit obtained by polymerizing a monomer (for example a vinyl ester), and then by reacting (for example by hydrolysis) the polymer obtained so as to obtain units of formula —CH₂—CH(OH)—.

In the present application, unless otherwise mentioned, the average molar masses are number-average molar masses, measured by stearic exclusion chromatography in an appropriate solvent, coupled to a multiangle light scattering detector (GPC-MALLS). In the present application, reference may also be made to theoretical average molar masses, determined from the masses of constituents used to prepare the polymers.

In the present application, the term “hydrophobic” is used in its usual sense of “that which has no affinity for water”; this means that the organic polymer of which it consists, taken alone, (of the same composition and of the same molar mass), would form a two-phase macroscopic solution in distilled water at 25° C., at a concentration of greater than 1% by weight.

In the present application, the term “hydrophilic” is also used in its usual sense of “that which has affinity for water”, i.e. that which is not capable of forming a two-phase macroscopic solution in distilled water at 25° C. at a concentration of greater than 1% by weight.

### Polymer

The ampholytic polymers comprise several units. Thus it is a copolymer. Copolymers are understood as polymers having several different units, as opposed to homopolymers. Copolymers include terpolymers. The zwitterionic polymers can be homopolymers or copolymers. The copolymers are preferably random copolymers. According to an advantageous embodiment, the copolymer is water-soluble soluble or water-dispersible. This means that said copolymer does not, over at least a certain pH and concentration range, form a two-phase composition in water, under the conditions of use.

The ampholytic polymers typically comprise:

cationic or potentially cationic units C,

anionic or potentially anionic units A, and

optionally non ionic, hydrophilic or hydrophobic units N.

The zwitterionic polymers typically comprise:

zwitterionic units Z, bearing a cationic charge and an anionic charge on the same unit,

optionally other units, being anionic or potentially anionic units, or non ionic hydrophilic or hydrophobic units.

The expression “cationic or potentially cationic units C” is intended to mean units that comprise a cationic or potentially cationic group. The cationic units or groups are units or groups that have at least one positive charge (generally associated with one or more anions such as the chloride ion, the bromide ion, a sulfate group, a methyl sulfate group), whatever the pH of the medium in which the copolymer is present. The potentially cationic units or groups are units or groups that may be neutral or may have at least one positive charge according to the pH of the medium in which the copolymer is present. In this case, reference will be made to potentially cationic units C in neutral form or in cationic form. By extension, reference may be made to cationic or potentially cationic monomers.

The expression “anionic or potentially anionic units A” is intended to mean units that comprise an anionic or potentially anionic group. The anionic units or groups are units or groups that have at least one negative charge (generally associated with one or more cations such as cations of alkali metal or alkaline earth metal, for example sodium, compounds, or cationic groups such as ammonium), whatever the pH of the medium in which the copolymer is present. The potentially anionic units or groups are units or groups that may be neutral or may have at least one negative charge according to the pH of the medium in which the copolymer is present. In this case, reference will be made to potentially anionic units A in neutral form or in anionic form. By extension, reference may be made to anionic or potentially anionic monomers.

The term “neutral units N” is intended to mean units that have no charge, whatever the pH of the medium in which the copolymer is present.

Examples of potentially cationic monomers (from which potentially cationic units can derive), include:
N,N-(dialkylamino-ω-alkyl)amides of α,β-monoethylenically unsaturated carboxylic acids, such as N,N-dimethylaminomethylacrylamide or -methacrylamide, 2-(N,N-dimethylamino)ethylacrylamide or -methacrylamide, 3-(N,N-dimethylamino)propylacrylamide or -methacrylamide, and 4-(N,N-dimethylamino)butylacrylamide or -methacrylamide,
α,β-monoethylenically unsaturated amino esters such as 2-(dimethylamino)ethyl acrylate (DMAA), 2-(dimethylamino)ethyl methacrylate (DMAM), 3-(dimethylamino)propyl methacrylate, 2-(tert-butylamino)ethyl methacrylate, 2-(dipentylamino)ethyl methacrylate, and 2(diethylamino)ethyl methacrylate,
vinylpyridines,
vinylamine,
vinylimidazolines,
monomers that are precursors of amine functions such as N-vinylformamide, N-vinylacetamide, etc., which give rise to primary amine functions by simple acid or base hydrolysis.

Examples of cationic monomers (from which cationic units can derive) include
acryloyl- or acryloyloxyammonium monomers such as trimethylammonium propyl methacrylate chloride, trimethylammonium ethylacrylamide or -methacrylamide chloride or bromide, trimethylammonium butylacrylamide or -methacrylamide methyl sulfate, trimethylammonium propylmethacrylamide methyl sulfate, (3-methacrylamidopropyl)trimethylammonium chloride (MAPTAC), (3-methacrylamidopropyl)trimethylammonium methyl sulphate (MAPTA-MES), (3-acrylamidopropyl)trimethylammonium chloride (APTAC), methacryloyloxyethyl-trimethylammonium chloride or methyl sulfate, and acryloyloxyethyltrimethylammonium chloride;
1-ethyl-2-vinylpyridinium or 1-ethyl-4-vinylpyridinium bromide, chloride or methyl sulfate;
N,N-dialkyldiallylamine monomers such as N,N-dimethyldiallylammonium chloride (DADMAC);
polyquaternary monomers such as dimethylaminopropylmethacrylamide chloride and N-(3-chloro-2-hydroxypropyl)trimethylammonium (DIQUAT), etc.

Examples of anionic or potentially anionic monomers (from which anionic or potentially anionic units can derive) include:
monomers having at least one carboxylic function, for instance α,β-ethylenically unsaturated carboxylic acids or the corresponding anhydrides, such as acrylic, methacrylic or maleic acids or anhydrides, fumaric acid, itaconic acid, N-methacroylalanine, N-acryloylglycine, and their water-soluble salts,
monomers that are precursors of carboxylate functions, such as tert-butyl acrylate, which, after polymerization, give rise to carboxylic functions by hydrolysis,
monomers having at least one sulfate or sulfonate function, such as 2-sulfooxyethyl methacrylate, vinylbenzene sulfonic acid, allyl sulfonic acid, 2-acrylamido-2-methylpropane sulfonic acid, sulfoethyl acrylate or methacrylate, sulfopropyl acrylate or methacrylate, and their water-soluble salts,
monomers having at least one phosphonate or phosphate function, such as vinylphosphonic acid, etc., the esters of ethylenically unsaturated phosphates, such as the phosphates derived from hydroxyethyl methacrylate (Empicryl 6835 from Rhodia) and those derived from polyoxyalkylene methacrylates, and their water-soluble salts.

Examples of hydrophobic non ionic monomers (from which hydrophobic non ionic units can derive) include:
vinylaromatic monomers such as styrene, alpha-methylstyrene, vinyltoluene, etc.,
vinyl halides or vinylidene halides, such as vinyl chloride, vinylidene chloride,
C₁-C₁₂ alkylesters of α,β-monoethylenically unsaturated acids such as methyl, ethyl or butyl acrylates and methacrylates, 2-ethylhexyl acrylate, etc.,
vinyl esters or allyl esters of saturated carboxylic acids, such as vinyl or allyl acetates, propionates, versatates, stearates, etc.,
α,β-monoethylenically unsaturated nitriles containing from 3 to 12 carbon atoms, such as acrylonitrile, methacrylonitrile, etc.,
α-olefins such as ethylene, etc.,
conjugated dienes, such as butadiene, isoprene, chloroprene.

Examples of non ionic hydrophilic monomers (from which hydrophilic non ionic units can derive), include:
hydroxyalkyl esters of α,β-ethylenically unsaturated acids, such as hydroxyethyl or hydroxypropyl acrylates and methacrylates, glyceryl monomethacrylate, etc.,
α,β-ethylenically unsaturated amides such as acrylamide, N,N-dimethylmethacrylamide, N-methylolacrylamide, etc.,
α,β-ethylenically unsaturated monomers bearing a water-soluble polyoxyalkylene segment of the poly(ethylene oxide) type, such as poly(ethylene oxide) α-methacrylates (Bisomer S20W, S10W, etc., from Laporte) or α,ω-dimethacrylates, Sipomer BEM from Rhodia (ω-behenyl polyoxyethylene methacrylate), Sipomer SEM-25 from Rhodia (ω-tristyrylphenyl polyoxyethylene methacrylate), etc.,
α,β-ethylenically unsaturated monomers which are precursors of hydrophilic units or segments, such as vinyl acetate, which, once polymerized, can be hydrolyzed in order to give rise to vinyl alcohol units or polyvinyl alcohol segments,
vinylpyrrolidones,
α,β-ethylenically unsaturated monomers of the ureido type, and in particular 2-imidazolidinone-ethyl methacrylamide (Sipomer WAM II from Rhodia).

Examples of zwitterionic monomers (from which zwitterionic units can derive) include:
sulfobetaine monomers, such as sulfopropyl dimethylammonium ethyl methacrylate (SPE from Raschig), sulfopropyldimethylammonium propylmethacrylamide (SPP from Raschig), and sulfopropyl-2-vinylpyridinium (SPV from Raschig),
phosphobetaine monomers, such as phosphatoethyl trimethylammonium ethyl methacrylate,
carboxybetaine monomers.

The copolymers can be prepared by conventional radical polymerization, or by any other polymerization process.

Especially preferred units C, from the lists above or not, include units deriving from:

MAPTAC, which is [3-(Methacryloylamino)propyl]trimethylammonium chloride

MAPTA-MES, which is [3-(Methacryloylamino)propyl]trimethylammonium Methyl sulfate

DADMAC, which is Diallyidimethylammonium chloride

DIQUAT, which is Methacryloamidopropyl-petamethyl-1,3-propylene-2-ol-amonium dichloride

ADAMQUAT, which is [2-(Acryloyloxy)ethyl]trimethylammonium (chloride, Methyl sulfate or other version)

MADAMQUAT, which is [2-(Methacryloyloxy)ethyl]trimethylammonium (chloride, Methyl sulfate or other version)

DMAEMA, which is which is N-[3-(Dimethylamino)ethyl]methacrylamide, or

DMAPMA, which is N-[3-(Dimethylamino)propyl]methacrylamide.

Especially preferred units C, from the lists above or not, include units deriving from:

Acrylic acid (AA), methacrylic acid,

vinyl sulphonate,

styrene sulphonate, or

AMPS, which is 2-acrylamide-2-methyl-1-propanesulfonic acid.

Especially preferred hydrophilic units N, from the lists above or not, include units deriving from:

acrylamide (AM), or

methacrylamide.

Especially preferred hydrophobic units N, from the lists above or not, include units deriving from:

styrene,

alkyl acrylates or methacrylates, wherein the alkyl group is for example a C₁-C₃₀ alkyl group.

Especially preferred units Z, from the lists above or not, include:

carboxybetaine units, carboxypyrrolidinium units,

sulfobétaïne units, sulfopyrrolidinium units,

phosphonobetaine units, or phosphonopyrrolidinium units.

Especially preferred polymers are the following:

a polymer deriving from MAPTAC, AA, and optionally AM,

a polymer deriving from DADMAC, AA, and optionally AM, the molar ratio between DADMAC and AA being preferably of higher than 50/50, preferably of higher or equal to 60/40, the molar ratio between (DADMAC and AA) and AM (if any), being preferably of higher than 67/33, or

a polymer deriving from DIQUAT, AA, and optionally AM, the molar ratio between DIQUAT and AA being preferably of from 20 to 80 to 80/20, the molar ratio between (DIQUAT and AA) and AM (if any), being preferably of higher than 67/33.

Useful amphoteric or zwitterionic polymers are for example marketed by Rhodia in a form of solutions comprising the polymer and acidic or basic fillers, as Mirapol Surf S 100, 110, 200, 210, 400, 410, 411, 500, 510. Other useful polymers also include Polyquart 149 marketed by Cognis.

### Composition

The composition comprising the polymer can be in different forms. The form usually depends upon the use of the composition. Thus the composition can be a fluid such as liquid, a gel, a foaming liquid. The composition can also be in a solid form to be rendered fluid in situ upon contact with a wet surface and/or with a wet application mean.

Liquid composition can be dispensed for example by spraying, by pouring or applying with a liquid dispensing device such as rollers or pumps. Such devices are application means.

The compositions can be diluted prior to being used, or during use. Dilution is preferably performed with water. Dilution rates usually depend upon the use of the composition. Furthermore dilutions approaches can depend upon the very consumer that uses the composition. For compositions that are to be diluted, dilution rates can be of from 5 to 2000, preferably 5 to 500 for example.

Where the composition is a liquid composition, for example a liquid concentrate composition, said composition can comprise a liquid medium, preferably an aqueous medium, an alcoholic medium, or a hydroxy-alcoholic medium. The medium can be a part of the composition, a part of a concentrate composition, or a part of a diluted composition, for example the diluting medium.

### Further Ingredients

The composition will usually comprise further ingredients of home-care, institutional-cleaning, or body-cleaning compositions. The further ingredients usually depend upon the use, destination and/or form of the composition. These further ingredients are known by the one skilled in the art of preparing compositions comprising several ingredients (or formulation) to serve a use or a market.

Thus the composition can comprise:

a carrier medium being an aqueous, alcoholic or hydroxyalcoolic medium,

the polymer,

optionally a surfactant, being an anionic surfactant, a non ionic surfactant, an amphoteric surfactant, a cationic surfactant, or mixture thereof,

optionally further ingredients.

Thus, the composition can comprise at least one surfactant. Compositions that comprise a surfactant are for example useful in compositions that are to provide cleaning or degreasing, such as hard-surface cleaning compositions, or personal cleansing products. Examples include liquid cleaning compositions, window cleaners composition, kitchen, bathroom or toilet cleaning compositions, shower rinse compositions, make-up removal compositions, cleansing compositions, greasy skin-care compositions.

Useful surfactants include anionic, non ionic, cationic, amphoteric (including zwitterionic) surfactants and mixtures thereof.

### Anionic Surfactants

Anionic surfactants useful in the present invention are preferably selected from the group consisting of, linear alkylbenzene sulfonates, alpha olefin sulfonates, paraffin sulfonates, methyl ester sulfonates, alkyl sulfates, alkyl alkoxy sulfates, alkyl sulfonates, alkyl alkoxy carboxylate, alkyl alkoxylated sulfates, sarcosinates, taurinates, and mixtures thereof.

One type of anionic surfactant which can be utilized encompasses alkyl ester sulfonates. These are desirable because they can be made with renewable, nonpetroleum resources. Preparation of the alkyl ester sulfonates surfactants components can be effected according to known methods disclosed in the technical literature. For instance, linear esters of C₈-C₂₀ carboxylic acids can be sulfonated with gaseous SO₃ according to “The Journal of the American Oil Chemists Society,” 52 (1975), pp. 323-329. Suitable starting materials would include natural fatty substances as derived from tallow, palm, and coconut oils, etc.

The preferred alkyl ester sulfonate surfactant, especially for laundry applications, comprises alkyl ester sulfonate surfactants of the structural formula:

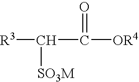

wherein R³ is a C₈-C₂₀ hydrocarbyl, preferably an alkyl, or combination thereof, R⁴ is a C₁-C₆ hydrocarbyl, preferably an alkyl, or combination thereof, and M is a soluble salt-forming cation. Suitable salts include metal salts such as sodium, potassium, and lithium salts, and substituted or unsubstituted ammonium salts, such as methyl-, dimethyl, -trimethyl, and quaternary ammonium cations, e.g. tetramethyl-ammonium and dimethyl piperidinium, and cations derived from alkanolamines, e.g. monoethanol-amine, diethanolamine, and triethanolamine.
Preferably, R³ is C₁₀-C₁₆ alkyl, and R⁴ is methyl, ethyl or isopropyl. Especially preferred are the methyl ester sulfonates wherein R³ is C₁₄-C₁₆ alkyl.

Alkyl sulfate surfactants are another type of anionic surfactant of importance for use herein. In addition to providing excellent overall cleaning ability when used in combination with polyhydroxy fatty acid amides (see below), including good grease/oil cleaning over a wide range of temperatures, wash concentrations, and wash times, dissolution of alkyl sulfates can be obtained, as well as improved formulability in liquid detergent formulations are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali or alkaline (Group IA or Group IIA) metal cation (e.g., sodium, potassium, lithium, magnesium, calcium), substituted or unsubstituted ammonium cations such as methyl-, dimethyl and trimethyl ammonium and quaternary ammonium cations, e.g., tetramethylammonium and dimethyl piperidinium, and cations derived from alkanolamines such as ethanolamine, diethanolamine, triethanolamine, and mixtures thereof, and the like. Typically, alkyl chains of C₁₂-C₁₆ are preferred for lower wash temperatures (e.g., below about 50° C.) and C₁₆-C₁₈ alkyl chains are preferred for higher wash temperatures (e.g., above about 50° C.). Examples of these surfactants include surfactants sold by Rhodia under the Rhodapan Trade Name.

Alkyl alkoxylated sulfate surfactants are another category of useful anionic surfactant. These surfactants are water soluble salts or acids typically of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines, e.g. monoethanolamine; diethanolamine, and triethanolamine, and mixtures thereof. Exemplary surfactants are C₁₂-C₁₈ alkyl polyethoxylate (1.0) sulfate, C₁₂-C₁₈ alkyl polyethoxylate (2.25) sulfate, C₁₂-C₁₈ alkyl polyethoxylate (3.0) sulfate, and C₁₂-C₁₈ alkyl polyethoxylate (4.0) sulfate wherein M is conveniently selected from sodium and potassium. Surfactants for use herein can be made from natural or synthetic alcohol feedstocks. Chain lengths represent average hydrocarbon distributions, including branching. Examples of these surfactants include surfactants sold by Rhodia under the Rhodapex Trade Name.

Other Anionic Surfactants—Other anionic surfactants useful for detersive purposes can also be included in the compositions hereof. These can include salts (including, for example, sodium, potassium, ammonium, and substituted ammonium salts such as mono-, di- and triethanolamine salts) of soap, C₈-C₂₀ linear alkylbenzenesulphonates, for example sold by Rhodia under the Rhodacal trande name, C₈-C₂₂ primary or secondary alkanesulphonates, C₈-C₂₄ olefinsulphonates, sulphonated polycarboxylic acids prepared by sulphonation of the pyrolyzed product of alkaline earth metal citrates, e.g., as described in British patent specification No. 1,082,179, alkyl glycerol sulfonates, fatty acyl glycerol sulfonates, fatty oleyl glycerol sulfates, alkyl phenol ethylene oxide ether sulfates, paraffin sulfonates, alkyl phosphates, isothionates such as the acyl isothionates, N-acyl taurates, fatty acid amides of methyl tauride, alkyl succinamates and sulfosuccinates, monoesters of sulfosuccinate, for example sold by Rhodia under the Geropon trade name (especially saturated and unsaturated C₁₂-C₁₈ monoesters) diesters of sulfosuccinate (especially saturated and unsaturated C₆-C₁₄ diesters), N-acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO⁻M+ wherein R is a C₈-C₂₂ alkyl, k is an integer from 0 to 10, and M is a soluble salt-forming cation, and fatty acids esterified with isethionic acid and neutralized with sodium hydroxide. Resin acids and hydrogenated resin acids are also suitable, such as rosin, hydrogenated rosin, and resin acids and hydrogenated resin acids present in or derived from tall oil.

Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

### Nonionic Surfactants

Suitable nonionic detergent surfactants are generally disclosed in U.S. Pat. No. 3,929,678, Laughlin et al., issued Dec. 30, 1975, at column 13, line 14 through column 16, line 6, incorporated herein by reference. Exemplary, non-limiting classes of useful nonionic surfactants include: alkyl dialkyl amine oxide, for example sold by Rhodia under the Rhodamox trade name, alkyl ethoxylate, for example sold by Rhodia under the Rhodasurf trade name, alkanoyl glucose amide, alkyl betaines, for example sold by Rhodia under the Mirataine trade name, and mixtures thereof.

Other nonionic surfactants for use herein include:

The polyethylene, polypropylene, and polybutylene oxide condensates of alkyl phenols. In general, the polyethylene oxide condensates are preferred. These compounds include the condensation products of alkyl phenols having an alkyl group containing from about 6 to about 12 carbon atoms in either a straight chain or branched chain configuration with the alkylene oxide. In a preferred embodiment, the ethylene oxide is present in a amount equal to from about 5 to about 25 moles of ethylene oxide per mole of alkyle phenol. Commercially available nonionic surfactants of this type include surfactants sold by Rhodia under the Igepal trade name. These are commonly referred to as phenol alkoxylates, (e.g., alkyl phenol ethoxylates).

The condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol.

Examples of commercially available nonionic surfactants of this type include TergitolB 15-S-9 (the condensation product of C₁₁-C₁₅ linear secondary alcohol with 9 moles ethylene oxide), Tergitol 24-L-6 NMW (the condensation product of C₁₂-C₁₄ primary alcohol with 6 moles ethylene oxide with a narrow molecular weight distribution), both marketed by Union Carbide Corporation; Neodol® 45-9 (the condensation product of C₁₄-C₁₅ linear alcohol with 9 moles of ethylene oxide), Neodol® 23-6.5 (the condensation product of C₁₂-C₁₃ linear alcohol with 6.5 moles of ethylene oxide), Neodol® 45-7 (the condensation product of C₁₄-C₁₅ linear alcohol with 7 moles of ethylene oxide), Neodol® 45-4 (the condensation product of C₁₄-C₁₅ linear alcohol with 4 moles of ethylene oxide), marketed by Shell Chemical Company, Rhodasurf IT, DB, and B marketed by Rhodia, Plurafac LF 403, marketed by BASF, and Kyro® EOB (the condensation product of C₁₃-C₁₅ alcohol with 9 moles ethylene oxide), marketed by The Procter & Gamble Company. Other commercially available nonionic surfactants include Dobanol 91-8® marketed by Shell Chemical Co. and Genapol UD-080® marketed by Hoechst. This category of nonionic surfactant is referred to generally as “alkyl ethoxylates.”

The condensation products of ethylene oxide with a hydrophobic base formed by the condensation of propylene oxide with propylene glycol. The hydrophobic portion of these compounds preferably has a molecular weight of from about 1500 to about 1800 and exhibits water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially-available Pluronic® surfactants, marketed by BASF, and Antarox, marketed by Rhodia.

The condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Examples of this type of nonionic surfactant include certain of the commercially available TetronicB compounds, marketed by BASF.

Semi-polar nonionic surfactants are a special category of nonionic surfactants which include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Semi-polar nonionic detergent surfactants include the amine oxide surfactants having the formula:

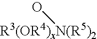

wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure. These amine oxide surfactants in particular include C₁₀-C₁₈ alkyl dimethyl amine oxides and C₈-C₁₂ alkoxy ethyl dihydroxy ethyl amine oxides.

Alkylpolysaccharides disclosed in U.S. Pat. No. 4,565,647, Llenado, issued Jan. 21, 1986, having a hydrophobic group containing from about 6 to about 30 carbon atoms, preferably from about 10 to about 16 carbon atoms and a polysaccharide, e.g., a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Optionally, and less desirably, there can be a polyalkylene-oxide chain joining the hydrophobic moiety and the polysaccharide moiety. The preferred alkyleneoxide is ethylene oxide. Typical hydrophobic groups include alkyl groups, either saturated or unsaturated, branched or unbranched containing from about 8 to about 18, preferably from about 10 to about 16, carbon atoms. Preferably, the alkyl group is a straight chain saturated alkyl group. The alkyl group can contain up to about 3 hydroxy groups and/or the polyalkyleneoxide chain can contain up to about 10, preferably less than 5, alkyleneoxide moieties. Suitable alkyl polysaccharides are octyl, nonyl, decyl, undecyldodecyl, tridecyl, tetradecyl, pentadecyl, hexadecyl, heptadecyl, and octadecyl, di-, tri-, tetra-, penta-, and hexaglucosides, galactosides, lactosides, glucoses, fructosides, fructoses and/or galactoses. Suitable mixtures include coconut alkyl, di-, tri-, tetra-, and pentaglucosides and tallow alkyl tetra-, penta-, and hexa-glucosides.

The preferred alkylpolyglycosides have the formula:

R²O(CₙH₂ₙO)ₜ(glycosyl)ₓ

wherein R² is selected from the group consisting of alkyl, alkyl-phenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the I-position). The additional glycosyl units can then be attached between their 1position and the preceding glycosyl units 2-, 3-, 4- and/or 6-position, preferably predominantly the 2-position.

Non ionic surfactant include fatty acid amide surfactants having the formula:

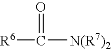

wherein R⁶ is an alkyl group containing from about 7 to about 21 (preferably from about 9 to about 17) carbon atoms and each R⁷ is selected from the group consisting of hydrogen, C₁-C₄ alkyl, C₁-C₄ hydroxyalkyl, and —(C²H₄O)ₓH where x varies from about 1 to about 3. Preferred amides are C₈-C₂₀ ammonia amides, monoethanolamides, diethanolamides, and isopropanolamides.

Non ionic surfactant include also derivates of terpenic compounds, for example NOPOL alkoxylates, such as NOPOL ethoxylates, propoxylates, radom or blocky ethopropolylates. Such compounds are marketed by Rhodia as Rhodoclean range.

### Cationic Surfactants

Cationic detersive surfactants can also be included in detergent compositions of the present invention. Cationic surfactants include the ammonium surfactants such as alkyldimethylammonium halogenides, and those surfactants having the formula: [R²(0R³)_{y}][R⁴(OR³)_{y}]₂R⁵N⁺X⁻ wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl, ring structures formed by joining the two R⁴ groups, —CH₂CHOHCHOHCOR⁶CHOH—CH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Other cationic surfactants useful herein are also described in U.S. Pat. No. 4,228,044, Cambre, issued Oct. 14, 1980, incorporated herein by reference.

### Other Surfactants

Ampholytic surfactants can be incorporated into the detergent compositions hereof. These surfactants can be broadly described as aliphatic derivatives of secondary or tertiary amines, or aliphatic derivatives of heterocyclic secondary and tertiary amines in which the aliphatic radical can be straight chain or branched. One of the aliphatic substituents contains at least about 8 carbon atoms, typically from about 8 to about 18 carbon atoms, and at least one contains an anionic water-solubilizing group, e.g., carboxy, sulfonate, sulfate. See U.S. Pat. No. 3,929,678 to Laughlin et al., issued Dec. 30, 1975 at column 19, lines 18-35 for examples of ampholytic surfactants. Preferred amphoteric include C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and mixtures thereof.

Zwitterionic surfactants can also be incorporated into the detergent compositions hereof. These surfactants can be broadly described as derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48 for examples of zwitterionic surfactants. Ampholytic and zwitterionic surfactants are generally used in combination with one or more anionic and/or nonionic surfactants.

Useful amphoteric surfactants include especially amphoacetates or diamphoacaetates, and bétaïnes (alkylbetaines and alkylamidoalkylbetaines).

### Other Optional Ingredients of the Composition Include:

thickening polymers,

hydrophilizing polymers (the function of hydrophilizing can be also delivered by the ampholytic or zwitterionic polymer),

deposition agents or deposition aid agents, for example deposition polymers, such as silicones,

anti-foaming agents,

foaming agents,

foam stabilizing and/or enhancing agents,

perfumes or fragrances,

builders (detergency adjuvants), including organic builders and inorganic builders,

buffers,

salts or fillers,

chelatants,

colorants,

preservatives,

enzymes,

corrosion inhibitors,

scale inhibitors,

dyes or pigments,

optical brighteners,

soiling suspending agents,

freezing-thawing stabilizers,

solvents,

opacifiers,

pearlescence agents.

The composition can include from 0.0001% by weight of the polymer to 5% by weight. The composition when applied (in a diluted form, or neat) has advantageously from 0.005 to 2%, preferably 0.01 to 0.5% by weight of the polymer.

The composition can be prepared conventionally by mixing the ingredients thereof. It can be further diluted by the final user.

### Process of Removing Dirt

The process comprises the steps of:
a) Applying fluid composition comprising an ampholytic or zwitterionic polymer onto the surface having dirt or make-up, by pouring or spraying the composition onto the surface or by using an application mean,
b) simultaneously or subsequently spreading and/or wiping the composition onto the surface, with a wiping or spreading fibrous or porous mean, and then,
c) optionally removing the liquid, or a part thereof, form the surface with a drying fibrous or porous mean,
some dirt or make-up being transferred from the surface to the application mean and/or the wiping mean and/or the spreading mean, and/or the drying mean.

The dirt to be removed and transferred to the typically comprises mineral particles such as:

carbon black,

carbon oxides,

clays,

pigments of a make-up composition or

mixtures thereof.

The dirt can also, additionally or alternatively, include greasy soils, sebum, or food.

The surface can be:

glass, for example comprised in windows,

tile or ceramic, for example comprised in kitchens, bathrooms, toilet bowls, showers, floors, or teeth

metal, for example comprised in window frames, or floors,

plastic, for example comprised in windows, furniture, or floors, especially in kitchen or bathroom furniture or panels, for example melamine, formica, linoleum,

wood or leather, optionally waxed, for example comprised in furniture or floor,

concrete, optionally waxed, for example comprised in floors,

the leave of a plant, or

a keratinous surface such as skin or hair.

In windows, floors, furniture or any other hard surface, the composition can be applied by any conventional mean, including direct spraying, spraying after dilution, application with using vehicles such as mops, pads, wipes, cloths, sponges, papers . . . .

### Step a) Application Step

Step a) is an application step of the composition. The composition is in a fluid form, and has been optionally diluted before.

In one embodiment Step a) is performed by pouring the composition onto the surface. Pouring can be performed from a recipient where the composition has been diluted such as a bucket, or from a dispensing bottle comprising the composition. The route from a dilution recipient is often used in dilutable cleaner and/or so called “all purpose cleaners”. The route from a dispensing bottle is often used in kitchen or bathroom cleaners. The dispensing bottle can be provided with appropriate means such as a pump or a mean that provides a jet upon applying a pressure on the bottle.

In another embodiment the composition is sprayed onto the surface. This is often used in kitchen, bathroom or windows cleaners. This is also used in floor cleaning devices provided with both a spraying nozzle and wiping or spreading fibrous or porous pads or wipes.

In another embodiment, the composition is applied, in a diluted or concentrate form, with an application mean such as a fibrous or porous mean, for example a sponge, a mop, a cloth, a fabric, a paper, a wipe. Thus the composition can be poured or spayed onto the application mean as described above. The application mean can be also impregnated completely with the composition, for example by immerging in the composition. This route is for example used when using “wet wipes” or when immerging a sponge, cloth, or mop into a recipient such as a bucket or a sink. The wipe is also referred to as a support of the composition. Then the application mean is applied onto the surface or is generally used as a wiping and/or spreading mean in step b).

In a particular embodiment, the composition is formed in situ by contacting a fibrous or porous support comprising the polymer onto a wet surface, or by contacting a fibrous or porous support comprising the polymer with water before applying said mean to the surface. In this embodiment the support and application mean can be a dry wipe.

Step b) Wiping or/and Spreading Step
Step b) is a wiping or spreading step. Wiping and/or spreading is the action of providing the composition on a larger area than the application area or than the application mean area, usually by moving a mean (wiping and/or spreading mean) up and down and/or right and left, and/or forward and backward. Upon applying some pressure the wiping and/or spreading can also be referred to as rubbing and/or scraping.

If step a) has been performed with an application mean such as a fibrous or porous mean, then step b) is usually indeed performed simultaneously, with the same mean (the wiping and/or spreading mean is the application mean).

If step b) has been preformed by pouring or spraying the composition onto the surface, then step b) is usually performed subsequently.

The wiping and/or spreading means can typically be a wipe, a cloth, a pad, a mop, a fabric or a paper.

### Step c) Drying Step

Step c) is a dying step. In this optional step possible excess of liquid is removed. This can be performed by letting the surface drying (no action), by heating, or by applying a substantially dry fibrous or porous mean onto the surface, such an absorbing paper, a fabric or sponge, or a wipe. Indeed some drying can occur simultaneously to wiping and/or spreading.

Transfer of the dirt or make-up from the surface can happen during one or several of steps a) to c), to the application mean and/or the wiping and/or spreading mean, and/or drying mean.

Advantageously:

the application mean and/or the wiping mean and/or the spreading mean, and/or the drying mean has a dirt or make-up transfer index DeltaE of higher then 2, preferably of higher than 5, and/or

the surface has a dirt or make-up transfer index DeltaE of higher then 2, preferably of higher than 5.

According to the invention, the application mean and/or the wiping mean and/or the spreading mean, and/or the drying mean is preferably visually dirtier after step b) or optional step c) then before. It is also preferred that the dirt or make-up transfer be higher than the dirt or make-up transfer than the dirt transfer obtained with the same process with a composition that does not comprise the ampholytic or zwitterionic polymer.

### Process Means and Fibrous or Porous Means

The application mean and/or the wiping mean and/or the spreading mean, and/or the drying mean, as mentioned above, can be for example:

a wipe

a cloth

a fabric

a pad, for example a cotton pad

a mop,

a sponge,

a fibrous puff, for example a cotton puff,

a cotton bud, or

an absorbing paper.

These mean are known from the one skilled in the art, and the literature comprise numerous descriptions of such means.

Fibrous means, such as wipes, are for examples non woven fabrics comprising fibers such as fibers of polyester, cellulose or cellulose derivatives (both being understood as cellulosic materials), polypropylene, and mixtures comprising such fibers.

Porous means include sponges.

Advantageously the application mean and/or the wiping mean and/or the spreading mean, and/or the drying mean, as mentioned above comprises a cellulosic material. It is for example:

a wipe, a cloth, a pad, a mop, an absorbing paper or a fabric comprising cellulosic fibers, or

a cellulosic or partly cellulosic sponge.

The application mean can be a support, supporting the composition, such as a wipe. The application mean can be the wiping mean and/or the spreading mean, and/or the drying mean, such as a wipe, a sponge, a mop, a pad, an absorbing paper or a cloth. It is mentioned that step a), step b) and optional step c) can be performed simultaneously with the same means and by a same wiping movement.

In one particular embodiment step a) comprises spraying the composition onto a surface, and step b) comprises wiping the surface with a fibrous or porous mean, for example a wipe, cloth, pad, or mop.

In one particular embodiment, the composition is a liquid cleaning composition, being applied onto the surface in a neat form or diluted form, being optionally diluted or further diluted in situ during application step a) or spreading or wiping step b).

In another particular embodiment, the composition is a liquid composition supported on a fibrous or porous support, said support being the application mean and/or the spreading or wiping mean, for example a wet wipe.

In another particular embodiment, the liquid composition is formed in situ when contacting with the surface being wet, a dry fibrous ou porous support comprising the polymer, said support being the application mean and/or the spreading or wiping mean, for example a dry wipe.

In another particular embodiment, the liquid composition is a non dilutable cleaner, such as a window cleaner or a toilet-bowl cleaner, being applied onto the surface in a neat form, being optionally diluted or further diluted in situ during application step a) or spreading or wiping step b).

The example below which is not limitative presents some further details or advantages of the invention.

### Examples

Standard wipes (viscose) from Eurowipes are impregnated with a kitchen cleaning type formulation.

Kitchen cleaner formulation:
Rhodoclean EFC: 1% (Rhodia)
Mirataine H2CHA: 0.9% (diamphoacetate surfactant, Rhodia)
IPA: 3%
Dowanol PNB: 3% (Solvent, Dow Chemical)
Mirapol Surf S 200: 3% or 0% (solution comprising an ampholytic polymer, Rhodia)
NaOH to adjust pH about 8
Water (pure) to 100%

Protocol for impregnation and drying:

### Impregnation

Wipes are impregnated in a beaker, with the tested formulation (2 g of solution for 1 g of wipe). Then, they are lightly wrung (no drop) and stored in closed airtight plastic bag in waiting the drying.

Wipes are stored in closed airtight plastic bag directly until application.

Then, performances are evaluated visually:

The surfaces are wiped with the wipe (humid). Surfaces for floor are the “natural floor” Surfaces for kitchen are the white ceramic tile treated with a kitchen soil.

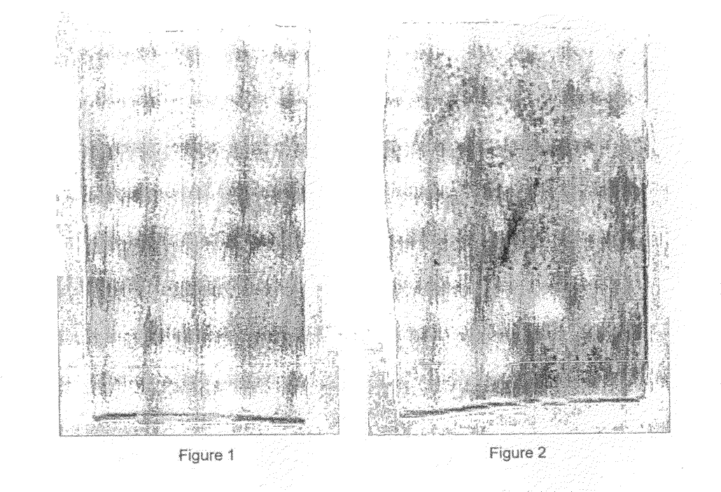

FIG. 1 is a picture after wiping of the wipe impregnated with a comparative composition that does not comprise Mirapol Surf S 200.

FIG. 2 is a picture after wiping of the wipe impregnated with the composition that comprises that Mirapol Surf S 200.

There is a visible “dirt pick up” with the wipes containing the ampholytic polymer.

1.-28. (canceled)

29. A process for the removal of dirt or make-up from an unclean surface soiled therewith, comprising (a) applying an ampholytic or zwitterionic polymer fluid composition thereon, (b) spreading and/or wiping said composition thereover, whereby dirt or make-up is or has been transferred into said composition, (c) optionally, if said composition comprises a liquid, drying same, and then (d) removing said composition and said dirt or make-up contained therein from said unclean surface.

30. The process as defined by claim 29, comprising pouring or spraying said fluid composition onto said unclean surface.

31. The process as defined by claim 30, comprising simultaneously or subsequently spreading and/or wiping said fluid composition onto said unclean surface utilizing a fibrous or porous wiping or spreading means.

32. The process as defined by claim 31, comprising removing said composition and said dirt or make-up contained therein from said unclean surface utilizing a fibrous or porous or, optionally, drying means.

33. The process as defined by claim 29, said unclean surface comprising a domestic or institutional hard surface, a tooth, a keratinous surface, skin or hair, or a plant.

34. The process as defined by claim 32, the application means and/or the wiping and/or the spreading means, and/or the drying means having a dirt or make-up transfer index DeltaE of greater than 2, and/or the surface having a dirt or make-up transfer index DeltaE of greater than 2.

35. The process as defined by claim 32, wherein the application means and/or the wiping means and/or the spreading means, and/or the drying means is visually dirtier after step (b) or optional step (c) then before.

36. The process as defined by claim 29, wherein the dirt or make-up transfer is higher than the dirt or make-up transfer than the dirt transfer obtained via the same process employing a composition that does not comprise the ampholytic or zwitterionic polymer.

37. The process as defined by claim 29, wherein the dirt transferred comprises carbon black, carbon oxides, clays, pigments of a make-up composition, or mixtures thereof, and/or greasy soils, sebum or food.

38. The process as defined by claim 29, said unclean surface comprising glass, tiles or ceramics, metals, plastics, wood, leather, the leaves of a plant, or a keratinous surface.

39. The process as defined by claim 32, wherein the application means and/or the wiping means and/or the spreading means, and/or the drying means, comprises a cellulosic material.

40. The process as defined by claim 39, wherein the application means and/or the wiping and/or the spreading means, and/or the drying means, comprises a wipe, a cloth, a pad, a mop, an absorbing paper, a fabric comprising cellulosic fibers, or a cellulosic or partly cellulosique sponge.

41. The process as defined by claim 32, wherein the application means comprises a support for said composition.

42. The process as defined by claim 32, wherein the application means comprises the wiping means and/or the spreading means, and/or the drying means, including a wipe, a sponge, a mop, a pad, an absorbing paper or a cloth.

43. The process as defined by claim 29, wherein step (a), step (b) and optional step (c) are carried out simultaneously with the same means and via a same wiping movement.

44. The process as defined by claim 29, wherein step (a) comprises spraying the composition onto a surface, and step (b) comprises wiping the surface with a fibrous or porous means.

45. The process as defined by claim 29, wherein the polymer comprises an ampholytic polymer which comprises:
cationic or potentially cationic units C,
anionic or potentially anionic units A, and
optionally non-ionic, hydrophilic or hydrophobic units N.

46. The process as defined by claim 45, the polymer comprising cationic or potentially cationic structural units deriving from cationic or potentially cationic monomers selected from the group consisting of:
MAPTAC, MAPTA-MES,
DADMAC,
DIQUAT,
ADAMQUAT, MADAMQUAT,
DMAEMA, and
DMAPMA.

47. The process as defined by claim 45, the polymer comprising anionic or potentially anionic units deriving from anionic or potentially anionic monomers selected from the group consisting of:
acrylic acid, methacrylic acid,
vinyl sulfonate,
styrene sulfonate, and
AMPS.

48. The process as defined by claim 45, the polymer comprising non-ionic hydrophilic units deriving from non-ionic hydrophilic monomers selected from the group consisting of:
acrylamide, methacrylamide.

49. The process as defined by claim 45, the polymer comprising non-ionic hydrophobic units deriving from non-ionic hydrophobic monomers selected from the group consisting of:
styrene, and
alkyl acrylates or methacrylates.

50. The process as defined by claim 45, the polymer comprising:
a polymer deriving from MAPTAC, AA, and optionally AM,
a polymer deriving from DADMAC, AA, and optionally AM, the molar ratio between DADMAC and AA being greater than 50/50, the molar ratio between (DADMAC and AA) and AM if any, being greater than 67/33, or
a polymer deriving from DIQUAT, AA, and optionally AM, the molar ratio between DIQUAT and AA ranging from 20 to 80 to 80/20, the molar ratio between (DIQUAT and AA) and AM if any, being greater than 67/33.

51. The process as defined by claim 29, comprises a zwitterionic polymer containing:
(a′) zwitterionic units bearing a cationic charge and an anionic charge on the same unit,
(b′) optionally other units, being anionic or potentially anionic units, or non-ionic hydrophilic or hydrophobic units.

52. The process as defined by claim 51, wherein the zwitterionic units are:
carboxybetaine units, carboxypyrrolidinium units,
sulfobetaine units, sulfopyrrolidinium units,
phosphonobetaine units, or phosphonopyrrolidinium units.

53. The process as defined by claim 29, wherein the composition comprises:
a carrier medium comprising an aqueous, alcoholic or hydroxyalcoholic medium,
the polymer,
optionally a surfactant, comprising an anionic surfactant, a non ionic surfactant, an amphoteric surfactant, a cationic surfactant, or mixture thereof, and
optionally, further ingredients.

54. The process as defined by claim 29, wherein the composition comprises a cleaning composition applied onto the unclean surface in a neat or diluted form, being optionally diluted or further diluted in situ during application step (a) or spreading or wiping step (b).

55. The process as defined by claim 29, wherein the composition comprises a liquid composition supported on a fibrous or porous support, said support comprising application means and/or spreading or wiping means therefor.

56. The process as defined by claim 53, wherein the liquid composition is formed in situ when contacting with the surface being wet, a dry fibrous or porous support comprising the polymer, said support comprising the application means and/or the spreading or wiping means.

57. The process as defined by claim 53, wherein the liquid composition comprises a non-dilutable cleaner, a window cleaner or a toilet-bowl cleaner, and is applied onto the surface in a neat form, being optionally diluted or further diluted in situ during application step (a) or spreading or wiping step (b).
